(19) United States
(12) Patent Application Publication
(10) Pub. No.: US 2022/0003653 A1
(43) Pub. Date: Jan. 6, 2022

(54) ISOVOLUMETRIC SPHERING OF RED BLOOD CELLS

(71) Applicant: Siemens Healthcare GmbH, Erlangen (DE)

(72) Inventors: Lukas Richter, Hirschaid (DE); Ann-Kathrin Reichenwallner, Au bei Bad Feilnbach (DE); Oliver Schmidt, Erlangen (DE); Gabriele Hornig, Fürth (DE); Manfred Ruhrig (deceased), Lauf (DE); Karl-Philipp Matheis, Alzey (DE); Matthias Ugele, Landshut (DE)

(21) Appl. No.: 17/289,722

(22) PCT Filed: Oct. 15, 2019
(86) PCT No.: PCT/EP2019/077849

§ 371 Date: Apr. 28, 2021

(30) Foreign Application Priority Data
Oct. 30, 2018 (EP) 18203264.9

(51) Int. Cl. G01N 15/14; G01N 1/44

(52) U.S. Cl. CPC G01N 15/1404; G01N 2015/0073; G01N 15/147; G01N 1/44

(57) ABSTRACT

An automatic analyzer for analyzing a medical probe includes an analysis cell for the probe, a piezo element, and an analysis device. The piezo element can be operated by applying a voltage and a frequency, and in the process an acoustic wave field is generated. A probe located in the analysis cell is located in the acoustic wave field when the piezo element is being operated.

### CROSS REFERENCE TO RELATED APPLICATIONS

This is a 371 of PCT/EP2019/077849, filed Oct. 15, 2019, which claims priority to European Patent Application No. EP 18203264.9, filed Oct. 30, 2018, both of which are hereby incorporated by reference herein in their entireties for all purposes.

### FIELD

The invention is in the field of automatic analyzers and relates to a hematology analyzer for analyzing cells in a sample.

### BACKGROUND

Automated cell counters are being used with increasing success for the automated analysis of cells. Examples thereof are the Advia 2120, Sysmex XE-2100, CellaVision DM96, and CellaVision DM1200 instrument. Besides their high throughput number, these automated instruments provide several advantages, such as, for example, high objectivity (no variability dependent on the observer), elimination of statistical variations that are usually associated with manual counting (counting of high cell counts), and the determination of numerous parameters that would not be available in the case of manual counting, and as discussed, more efficient and more cost-effective handling. Some of these instruments can process 120 to 150 patient samples per hour.

The technical principles of automatic single-cell counting are usually based either on an impedance (resistance) measurement or on an optical system (scattered light or absorption measurement). There are also established imaging systems which, for example, image and assess cells of a blood smear in an automated manner.

In the case of the impedance method, cell counting and size determination thereof is done on the basis of the detection and measurement of changes in electrical conductivity (resistance) that are caused by a particle moving through a small opening. Particles, such as, for example, blood cells, are themselves nonconductive, but are suspended in an electrically conductive diluent. If such a suspension of cells is guided through an opening, the impedance (resistance) of the electrical path between the two electrodes situated on either side of the opening temporarily increases upon passage of a single individual cell.

In contrast to the impedance method, the optical method comprises guiding a laser light beam or an LED light beam through a diluted blood sample, which is captured by the laser beam or the LED light beam in a continuous stream. In this connection, the relevant light beam can, for example, be guided toward the flow cell by means of an optical waveguide. Any cell passing through the capture zone of the flow cell scatters the focused light. The scattered light is then detected by a photodetector and converted into an electrical pulse. The number of pulses that is generated here is directly proportional to the cell count passing through the capture zone within a specific time span.

In the case of the optical methods, the light scattering of the single cell passing through the capture zone is measured at various angles. What is captured as a result is the scattering behavior of the cell in question for the optical radiation, which scattering behavior makes it possible to draw conclusions about, for example, cell structure, shape, and reflectance. The scattering behavior can be used to differentiate between various types of blood cells and to use the derived parameters for diagnosis of deviations of the blood cells of this sample from a standard obtained, for example, from a multiplicity of reference samples classified as normal.

In the case of the automated assessment of cells in, for example, blood smears, the analyzers of today operate with microscopes having a high numerical aperture and having immersion between the slide and the objective in order to be able to achieve a high resolution. However, what arises as a result is a comparatively small depth of field which is distinctly smaller than the thickness of the cells perpendicular to the surface of the slide containing the blood smear. Accordingly, with two-dimensional imaging in only one focus setting, it is not possible to sharply image the entire depth information of the cells. Therefore, what frequently occur are unclearly classified blood cells that have to be manually reclassified by trained personnel, for example, a laboratory physician.

The measurement instruments currently in use in hematology comprise, with regard to the optical system, a microscope having about 100× magnification with effective lateral resolutions of a sensor element on the object plane of 100 nm=0.1 μm. The cameras in use have pixel counts of not more than 0.3 to 1 million pixels. As a result, the field of view in the object is only a few hundred μm in size. To be able to record and analyze the stained smear of a blood sample that may be several mm in width and several tens of mm in length, the area of the region of the smear that is to be analyzed must then be scanned using a sliding unit in a meandering scanning method. To speed up the process somewhat, a first areal scan is carried out with low magnification, for example, 10× with a field of view correspondingly 10× larger and, after a first image evaluation to find the cells to be measured, then only the regions of interest (RoI) containing the cells are subsequently specifically approached with the higher magnification. This means that a complete areal analysis of the sample with the high magnification does not take place. To make the cells sufficiently highly visible in order to be able to analyze them with high-resolution optical microscopy, the blood smears are stained in an upstream step. Multiple staining protocols have become established worldwide, these showing some differences globally from region to region. Therefore, the comparability of the analysis of blood smears is regionally restricted, since only images of cells which have been stained according to the same protocol can be compared with one another effectively.

For the analysis of red blood cells (RBCs), they are rounded particularly in flow systems, this process also being referred to as sphering.

The rounding or sphering of native biconcave red blood cells allows a precise analysis of their volume and further parameters with the aid of geometric formulas; see, for example, Y. C. B. Fung and P. Tong “Theory of the sphering of red blood cells”, Biophysical Journal, volume 8 (1968).

In this connection, the process of sphering should in practice be easily integrable into a complex sample preparation process, as is typically present in the case of a hematology machine, in order to achieve a rapid workflow and, at the same time, a high sample throughput.

Isovolumetric sphering is used in known hematology analyzers by admixing of the sample with a hypotonic buffer, which commonly additionally contains a cell membrane-destabilizing agent such as, for example, sodium dodecyl sulfate (SDS). The use of hypotonic liquids for sphering results in a very high dilution of the sample by, for example, a factor of 630. Furthermore, this approach for isovolumetric sphering leads to the red blood cells being present in a state greatly differing from a native state. A particular contribution to this can also be made by the combination of the hypotonic liquid and the cell membrane-destabilizing agent.

The analysis of these sphered cells encompasses, for example, a determination of their volume or of the hemoglobin and is carried out in hematology analyzers, for example, optically by use of monochromatic light generated by laser or LED and also the application of Mie theory for evaluation of spherical objects. Alternatively, the sphered cells can also, for example, be analyzed impedimetrically by measurement of conductivity in a defined volume of an ion-containing liquid (Coulter principle).

Also known are methods in which heat in the form of a water bath adjusted to an appropriate temperature is used in order to sphere red blood cells; see, for example, N. Matsumoto, Y. Yawata, and H. S. Jocob, “Association of Decreased Membrane Protein Phosphorylation With Red Blood Cell Spherocytosis,” Blood, volume 49, No. 2 (February) (1977). It may be possible here, to some degree, to dispense with very high dilution of the sample. However, the heating can very easily lead to further changes to the red blood cells, such as, for example, agglutination of the proteins in and on the blood cells, the result being that the morphology of the red blood cells changes very greatly because of overheating and makes an appropriate, precise analysis of the cells impossible.

Furthermore, an imaging analysis requires that the sphered red blood cells be brought into the optical focus of a microscope in order to subsequently allow a precise image analysis.

### SUMMARY OF THE INVENTION

It is therefore an object of the invention to provide an automatic analyzer for analyzing a medical sample and a method for sphering a cell of a medical sample, wherein the sphering of the cell can be achieved without a very high dilution of the sample and, at the same time, the cells can be analyzed in a state that is as original as possible and shows little or no change at all apart from the sphering, i.e., for example, chemical pretreatments of the cells are to be omitted as far as possible, and labeling of the cells can ideally be completely dispensed with. Furthermore, the disadvantages which arise in the case of the known methods that used heat for sphering are also to be avoided. For example, what is to be avoided is agglutination of the proteins in and on the cells and a morphology change caused thereby because of overheating. It is a further object of the invention to bring the cells, sphered in an appropriately gentle and label-free manner, into the optical focus of a microscope in order to subsequently allow a precise image analysis.

The object is achieved by an analyzer according to the invention and the methods according to the invention as per the independent claims. Advantageous developments of the invention are particularly also given by the dependent claims.

The invention provides particularly an analyzer for analyzing a medical sample, the analyzer comprising an analysis cell for the sample, a piezo element, and an analysis device, wherein the piezo element can be operated by application of a voltage and a frequency and generates an acoustic wave field, wherein a sample situated in the analysis cell is situated in the acoustic wave field during operation of the piezo element.

An analyzer according to the invention has the advantage that it is possible to dispense with the hitherto necessary use of hypotonic buffers and a cell membrane-destabilizing agent for sphering of cells. Furthermore, a very high dilution of the sample is no longer necessary and, at the same time, the disadvantages which arise in the case of conventional heating by means of a water bath are also avoided as far as possible. Furthermore, the sphered cells can, by means of the acoustic wave field generated and the corresponding acoustic forces, simultaneously also be brought into and/or held in the optical focus of a microscope in order to subsequently allow a precise image analysis. Furthermore, it is possible to fully or partially dispense with staining or other labeling of the samples for the subsequent microscopy.

Preferably, the analyzer according to the invention is an automatic analyzer, particularly preferably a semiautomatic or fully automatic analyzer. Furthermore, the analyzer is preferably a hematology analyzer, particularly preferably an automatic hematology analyzer.

In a preferred embodiment of the analyzer, a sample situated in the analysis cell is heated by the wave field during operation of the piezo element, preferably to at least 48 degrees Celsius, particularly preferably to at least 50 degrees Celsius. This has the advantage that complete sphering of red blood cells can be achieved in a reliable manner.

In a preferred embodiment of the analyzer, the piezo element is operated by application of a voltage of 35 volts to 100 volts, preferably 40 to 80 volts, particularly preferably of 75 volts, and a frequency of about 1 MHz, preferably 1.113 MHz, or a frequency of about 5 MHz, preferably 5.397 MHz. This has the advantage that a cell of a medical sample that is situated in the analysis cell can be heated to a temperature of 48 or 50 degrees Celsius in a particularly safe, rapid, and efficient manner.

In a further preferred embodiment of the analyzer, the analysis cell is a flow cell, preferably a microfluidic flow cell. This has the advantage that an optimized workflow and a high sample throughput can be achieved. Furthermore, this has the advantage that the cells can be analyzed in a fluid environment and hence under more native conditions. Preferably, the sample moves within the analysis cell at a flow rate between 0.002 and 5 mm per second, particularly preferably between 0.002 and 0.1 mm per second. At the same time, the flow conditions are advantageously laminar.

In a further preferred embodiment of the analyzer, the analysis device comprises an optical microscope, preferably a digital holographic microscope (DHM), for analysis of a sample situated in the analysis cell. Preferably, the microscope comprises a 20× to 60× objective. This has the advantage that the magnification can be adjusted such that the sphered red blood cells can be imaged with sufficient sharpness with one focus setting.

In a further preferred embodiment of the analyzer, a cell of a medical sample that is situated in the analysis cell is brought into and/or held in the focus region of the microscope by means of acoustic forces, the acoustic forces being generated by means of the piezo element. Preferably, the voltage applied for this purpose is 8 to 12 volts and the frequency is about 1 MHz, preferably 1.113 MHz, or about 5 MHz, preferably 5.397 MHz. This has the advantage that the cell can be brought into or held in the focus region in a contactless manner. At the same time, there is no heating of the cell and accordingly no thermally induced morphological change in the cell, as occurs in the case of higher voltages. The cells thus do not become spherical but remain biconcave.

The invention further provides a method for sphering a cell of a medical sample by means of heating, wherein the cell is situated in an analysis cell and wherein an acoustic wave field is generated by means of a piezo element operated at a voltage and a frequency and wherein the cell is situated in the wave field and is heated and thereby sphered by the wave field.

In a preferred embodiment of the method, the sphering is done isovolumetrically. This has the advantage that the cell volume, of the red blood cell for example, remains unchanged by the sphering. This can be of great importance for a corresponding quantitative, precise analysis of the cell volume.

In a further preferred embodiment of the method, the cell is heated to at least 48 degrees Celsius, particularly preferably to at least 50 degrees Celsius. This has the advantage that complete sphering of red blood cells can be achieved in a reliable manner.

In a further preferred embodiment of the method, the cell moves within the analysis cell at a flow rate between 0.002 and 5 mm per second, particularly preferably between 0.002 and 0.01 mm per second.

In a further preferred embodiment of the method, the cell is analyzed and/or imaged by means of an analysis device comprising an optical microscope, preferably a digital holographic microscope (DHM), after the sphering, wherein the cell is preferably situated in a focus region of the microscope during the analysis and/or imaging. This has the advantage that it is possible to achieve imaging of the cells in high quality and it is thus possible to achieve a precise, quantitative analysis of the cell volume for example or other cell parameters.

In a further preferred embodiment of the method, the cell is brought into and/or held in the focus region of the microscope by acoustic forces, wherein this is preferably done at the same time as the sphering of the cell.

In a further preferred embodiment of the method, the cell is brought into and/or held in the focus region of the microscope by simultaneous use of acoustic and microfluidic forces, wherein this is preferably done at the same time as the sphering of the cell.

Preferably, the acoustic forces for bringing and/or holding the cell into/in the focus region of the microscope are generated by means of the piezo element. Preferably, the voltage applied for this purpose is 8 to 12 volts and the frequency is about 1 MHz, preferably 1.113 MHz, or about 5 MHz, preferably 5.397 MHz.

In a further preferred embodiment of the method, the sphering of the cell within a flow cell takes place in a first region of the flow cell, preferably by means of a frequency of 1 MHz, particularly preferably 1.113 MHz, applied to the piezo element. Preferably, the first region of the flow cell is situated upstream of the focus region of the microscope. The focus region of the microscope is situated in a second region of the flow cell, the first region being preferably arranged upstream of the second region. Preferably, the raising of the cell into the focus region of the microscope then takes place downstream in the second region of the flow cell, preferably by means of a frequency of 5 MHz, particularly preferably 5.397 MHz, applied to the piezo element. This has the advantage that sphering of the cell without further undesired thermally induced further changes on the cell is possible even if simultaneous sphering and focusing would entail such undesired changes and/or it were not possible to rule out such changes.

In a further preferred embodiment of the method, the cell is analyzed and/or imaged immediately after the sphering, preferably within 0.05 to 1 second after the sphering. This has the advantage that undesired changes to the cell that may occur because of the heating or overheating of the cell only occur at a time at which the analysis and/or the imaging of the cell has already been completed.

In a further preferred embodiment of the method, the cell is a human or animal cell, preferably a blood cell, particularly preferably a red blood cell.

In a further preferred embodiment of the method, the cell is a red blood cell and wherein the analysis of the cell comprises a volume determination and/or a determination of single-cell hemoglobin (MCH) and/or a detection of malaria parasites.

The invention further provides for use of a method according to the invention in an automatic analyzer, preferably in an automatic analyzer according to the invention.

Preferably, the medical sample encompasses a cell and/or a medical preparation. Preferably, the medical preparation is a tissue section, sediments from body secretions and/or body fluids and/or microcrystals. This has the advantage that a very wide variety of different sample types, including a very wide variety of different cell types, can be tested and characterized.

### BRIEF DESCRIPTION OF THE DRAWINGS

The invention will be more particularly elucidated once more by a specific exemplary embodiment with reference to the attached drawings. The example shown is a preferred embodiment of the invention. In the figures:

FIG. 1 shows an analysis cell (9) in which red blood cells (7) are situated without acoustophoretic heating, wherein a piezo element (1) is operated at 23 volts,

FIG. 2 shows an analysis cell (9) in which sphered red blood cells (7) are situated with acoustophoretic heating, wherein a piezo element (1) is operated at 75 volts,

FIG. 3 shows an analysis cell (9) in which red blood cells (7) are situated, wherein a piezo element (1) is operated at 23 volts,

FIG. 4 shows an analysis cell (9) in which sphered red blood cells (7) are situated, wherein a piezo element (1) is operated at 75 volts.

### DETAILED DESCRIPTION OF THE INVENTION

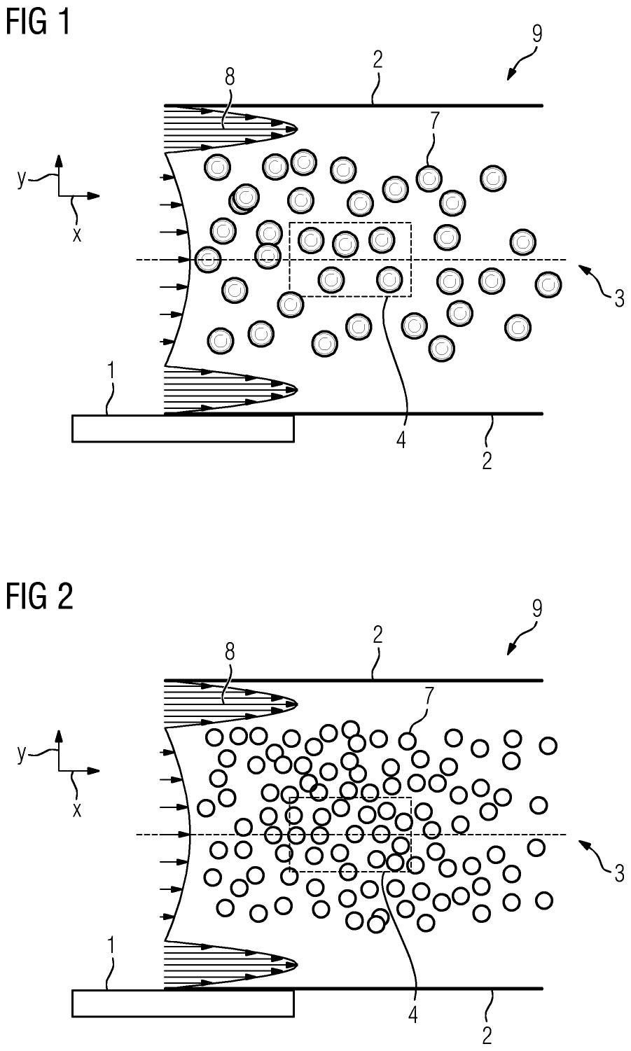

The analysis cell (9) shown in FIG. 1 comprises channel walls (2) and a piezo element (1) and is part of an automatic analyzer for analyzing cells in a sample. The analyzer comprises an analysis device (10) which is configured as an optical microscope and which comprises a light source for illumination of a sample in the analysis cell (9) and a converging lens for convergence and focusing of light beams proceeding from the illuminated sample. The sample is a blood sample which contains red blood cells (7). The sample is situated in the analysis cell (9), which is configured as a microfluidic flow cell. Furthermore, the microscope comprises a camera comprising a digital recorder, the recorder comprising a CCD chip or a CMOS chip, for recording of the light field imaged in the microscope. The analysis cell (9) and the microscope are configured such that red blood cells (7) situated in an optical window (4) can be imaged and analyzed. The piezo element (1) is arranged in the outer region on the channel wall (2) immediately before the optical window (4) in flow direction x of the red blood cells (7). A velocity profile (8) of the red blood cells (7) moving in direction x within the flow cell is represented as a vector depending on the position of the red blood cells in direction y.

The piezo element (1) is operated at a voltage of 25 volts and a frequency of about 1 MHz, preferably 1.113 MHz, or at a voltage of 25 volts and a frequency of about 5 MHz, preferably 5.397 MHz. The temperature of the red blood cells (7) is less than 48 degrees Celsius and the red blood cells (7) are present in their native state and are not sphered.

FIG. 2 shows the same analysis cell (9) as in FIG. 1. Now, the piezo element (1) is operated at a voltage of 75 volts and a frequency of about 1 MHz, preferably 1.113 MHz, or at a voltage of 75 volts and a frequency of about 5 MHz, preferably 5.397 MHz. The temperature of the red blood cells (7) is at least 48 degrees Celsius and the red blood cells (7) are sphered.

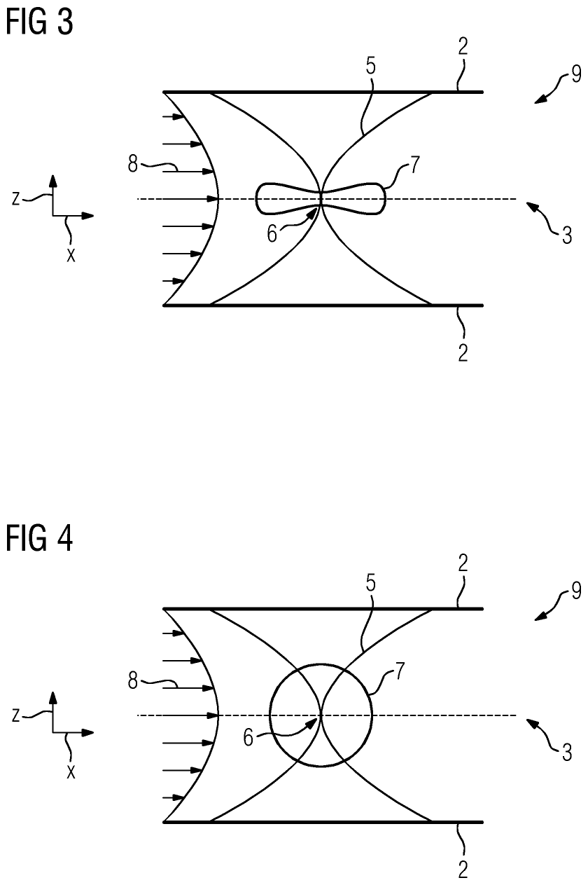

FIG. 3 shows a further analysis cell (9) in which a red blood cell (7) is situated. A velocity profile (8) of the red blood cells (7) moving in direction x within the flow cell is represented as a vector depending on the position of the red blood cells in direction z. A piezo element (1) (not shown) is arranged in the region of the outer side of the channel wall and is operated at a voltage of 23 volts and a frequency of about 1 MHz, preferably 1.113 MHz, or at a voltage of 23 volts and a frequency of about 5 MHz, preferably 5.397 MHz. The temperature of the red blood cells (7) is 36 degrees Celsius and the red blood cell (7) is present in its native state and is not sphered. What is shown is the progression of the acoustic wave (5) generated by the piezo element (1). An acoustic wave node (6) is present in the region of the channel half-height (3) and of the red blood cell (7). Owing to acoustic forces, the red blood cell (7) is drawn into the region of the acoustic wave node and held there.

FIG. 4 shows the same analysis cell (9) as in FIG. 3. The piezo element (1) is operated at a voltage of 75 volts and a frequency of about 1 MHz, preferably 1.113 MHz, or at a voltage of 75 volts and a frequency of about 5 MHz, preferably 5.397 MHz. The temperature of the red blood cell (7) is 48 degrees Celsius and the red blood cell (7) is completely sphered. What is shown is the progression of the acoustic wave (5) generated by the piezo element (1). An acoustic wave node (6) is present in the region of the channel half-height (3) and of the red blood cell (7). Owing to acoustic forces, the red blood cell (7) is drawn into the region of the acoustic wave node and held there.

### LIST OF REFERENCE SIGNS

1 Piezo element
2 Channel wall
3 Channel half-width
4 Optical window
5 Acoustic wave
6 Acoustic wave node
7 Red blood cell (RBC)
8 Velocity profile
9 Analysis cell

1. An automatic analyzer for analyzing a medical sample, the analyzer comprising an analysis cell for the sample, a piezo element, and an analysis device, wherein the piezo element can be operated by application of a voltage and a frequency and generates an acoustic wave field, wherein a sample situated in the analysis cell is situated in the acoustic wave field during operation of the piezo element.

2. The automatic analyzer as claimed in claim 1, wherein a sample situated in the analysis cell is heated by the wave field during operation of the piezo element to at least 48 degrees Celsius.

3. The automatic analyzer as claimed in claim 1, wherein the analysis cell is a flow cell.

4. The automatic analyzer as claimed in claim 3, wherein the sample moves within the analysis cell at a flow rate between 0.002 and 5 mm per second.

5. The automatic analyzer as claimed in claim 1, wherein the analysis device comprises an optical microscope for analysis of a sample situated in the analysis cell.

6. The automatic analyzer as claimed in claim 5, wherein the microscope comprises a 20× to 60× objective.

7. The automatic analyzer as claimed in claim 1, wherein a sample is situated in the analysis cell and the sample comprises human or animal cells.

8. A method for sphering a cell of a medical sample comprising:
providing the cell situated in an analysis cell; and
generating an acoustic wave field using a piezo element operated at a voltage and a frequency wherein the cell is situated in the wave field and is heated and thereby sphered by the wave field.

9. The method as claimed in claim 8, wherein the sphering is done isovolumetrically.

10. The method as claimed in claim 8, wherein the cell is heated to at least 48 degrees Celsius.

11. The method as claimed in claim 8, wherein the analysis cell is a flow cell.

12. The method as claimed in claim 8, further comprising moving the cell within the analysis cell at a flow rate between 0.002 and 5 mm per second.

13. The method as claimed in claim 8, further comprising analyzing or imaging the cell with an analysis device comprising an optical microscope after the sphering, wherein the cell is situated in a focus region of the microscope during the analyzing or imaging.

14. The method as claimed in claim 13, further comprising bringing or holding the cell in the focus region of the microscope by simultaneous use of acoustic and microfluidic forces.

15. The method as claimed in claim 13, wherein the analyzing or imaging the cell occurs within 0.05 to 1 second after the sphering.

16. The method as claimed in claim 8, wherein the cell is a human or animal cell.

17. The method as claimed in claim 13, wherein the cell is a red blood cell and the analyzing of the cell comprises a volume determination or a determination of single-cell hemoglobin (MCH) or a detection of malaria parasites.

18. The method as claimed in claim 8, wherein the cell is heated to at least 50 degrees Celsius.

19. The method as claimed in claim 8 further comprising moving the cell within the analysis cell at a flow rate between 0.002 and 0.1 mm per second.

20. The automatic analyzer as claimed in claim 5, wherein the optical microscope is a digital holographic microscope (DHM).
